(19) United States
(12) Patent Application Publication
(10) Pub. No.: US 2010/0179069 A1
(43) Pub. Date: Jul. 15, 2010

(54) METHOD AND APPARATUS FOR CONDUCTING HIGH-THROUGHPUT MICRO-VOLUME EXPERIMENTS

(75) Inventor: Jiang Huang, San Jose, CA (US)

Correspondence Address: LESTER H. BIRNBAUM, 6 OAKMOUNT COURT, SIMPSONVILLE, SC, 29681, US

(73) Assignee: GN Biosystems Incorporated

(21) Appl. No.: 12/451,801

(22) PCT Filed: Jul. 22, 2008
(86) PCT No.: PCT/US08/08898

§ 371 Date: Dec. 1, 2009

Related U.S. Application Data
(60) Provisional application No. 60/962,528, filed on Jul. 30, 2007.

(51) Int. Cl. C40B 30/04; C40B 60/12

(52) U.S. Cl. 506/9; 506/39

(57) ABSTRACT

An apparatus and a method for conducting high-throughput micro-volume dialysis-based experiments are disclosed. The apparatus includes a microfluidic base plate comprising one or more through-holes, each of the one or more through-holes being interconnected through a microfluidic channel. Each through-hole is covered by a dialysis membrane. Further, the two ends of the microfluidic channel are connected to a sample inlet port and a sample outlet port respectively. The apparatus further includes a microtiter plate comprising multiple wells. The microtiter plate is attached to the microfluidic base plate in such a way that at least one well overlies at least one through-hole, with the dialysis membrane in between. The method for conducting the high-throughput micro-volume dialysis-based experiments comprises adding reagents into the wells overlying the through-holes, and loading micro-volume samples into the through-holes. The reagents get diffused from the wells, through the dialysis membrane, and into the through-holes for reaction.

### BACKGROUND

The invention relates, in general, to an apparatus and a method for conducting high-throughput micro-volume experiments. More specifically, the invention relates to a microfluidic device for conducting high-throughput micro-volume dialysis-based experiments.

Micro-volume experiments are small-scale experiments that are conducted at a volume of microliters, nanoliters, and picoliters. With the ongoing developments in the fields of genomics and proteomics, there is an increasing need for such miniaturization of biological and chemical experiments. These experiments are generally used in structural biology and drug screening, sample preparation, chemical/biological analysis, bioseparations, and controlled drug delivery. Examples of such experiments include protein crystallization reactions, protein binding reactions, and protein purification reactions.

Micro-volume experiments may be either dialysis based or non-dialysis based. Dialysis-based experiments are those which involve the use of a semi-permeable membrane for separating samples of specific molecular weight. Examples of dialysis-based experiments include dialysis-based protein crystallization, protein equilibrium dialysis, protein purification, and protein-drug binding assays.

Micro-volume dialysis-based protein crystallization involves separation of protein samples and crystallization reagents by a semi-permeable dialysis membrane. Diffusion and equilibration of small precipitant molecules through the dialysis membrane act as a means of slowly approaching the concentration at which the protein sample crystallizes. Further, the dialysis membrane is designed with a particular molecular weight cut-off that is less than the molecular weight of the protein in the sample and higher than the molecular weight of each of the crystallization reagents. As a result, the protein is retained on one side of the dialysis membrane. On the other hand, there is controlled movement of the crystallization reagents across the dialysis membrane such that when the conditions are right, crystallization of the protein may be induced.

High-throughput micro-volume experiments such as high-throughput dialysis-based experiments require the use of microfluidic devices. A microfluidic device includes a microtiter plate and a dialysis membrane. A high-density microtiter plate such as a 1536 well microtiter plate is widely used. However, the use of high-density microtiter plates leads to rapid evaporation of samples with reaction volumes of 1 μl or less. Rapid evaporation is even more detrimental in case of samples with reaction volumes of 100 nl or less. Although rapid motion sub-microliter liquid dispensing robotic machines help alleviate some of the problems, the variations in liquid dispensing are generally high. This results in inefficient and inaccurate high-throughput micro-volume experiments. Moreover, these robotic machines are generally expensive. Further, the dialysis membrane used in the microfluidic device requires a manual setting, which is labor-intensive, time-consuming, cost-prohibitive (due to large protein consumption), and difficult to automate. This may also result in an inefficient handling of samples. Additionally, rubber-based gaskets are used to fix the dialysis membrane. However, the use of such gaskets is not practical with microfluidic devices involving reaction volumes of 1 μl or less. Still further, conventional microfluidic devices are not very efficient in handling very small volumes of samples, which leads to wastage of expensive samples.

Additionally, due to the factor that most microfluidic devices are completely enclosed systems, it becomes very difficult to harvest protein crystals yielded from most of the currently available microfluidic protein crystallization devices such as a polydimethylsiloxane (PDMS) based microfluidic device. Protein crystal harvesting is a key step in achieving the final goal of protein structure elucidation, as protein crystals are required for examination by X-ray to obtain the necessary information for protein structure determination. In the PDMS based microfluidic device, protein crystal harvesting involves cutting and opening of the PDMS chip, and scooping the protein crystals with the help of a loop. Other conventional microfluidic devices may involve the use of air pressure for harvesting the protein crystals. However, protein crystals harvested using the above mentioned techniques are usually stressed and damaged.

In light of the foregoing discussion, there is a need for an apparatus and a method that is efficient in conducting high-throughput micro-volume dialysis-based experiments. The apparatus should preferably be capable of handling fluids with volumes in microliters, nanoliters, and picoliters. The apparatus and the method should preferably be cost-effective. Further, the apparatus should preferably be able to reduce the rapid evaporation of samples or reagents associated with micro-volume experiments. Additionally, the apparatus should preferably use an easy and effective method for harvesting protein crystals to conduct a typical protein crystallization reaction.

### SUMMARY

An objective of the invention is to provide an apparatus and a method for conducting high-throughput micro-volume experiments involving volumes in microliters, nanoliters, and picoliters. More specifically, the objective of the invention is to provide the apparatus and the method for conducting high-throughput micro-volume dialysis-based experiments.

Another objective of the invention is to provide a cost-effective method for conducting micro-volume dialysis-based experiments. Using the present invention, micro-volume dialysis-based experiments, such as protein crystallization involving 5 μl of sample volume per reaction or less, are effectively carried out.

Further, another objective of the invention is to provide a microfluidic device that employs an easy and effective method for micro-volume sample loading without the use of expensive sub-microliter liquid dispensing robotic machines.

Yet another objective of the invention is to provide an apparatus and a method that is capable of reducing rapid evaporation of samples or reagents associated with micro-volume experiments. This is achieved by the use of microfluidic channels and through-holes in the apparatus.

Still another objective of the invention is to provide an apparatus for conducting high-throughput micro-volume dialysis-based experiments that allow easy and efficient harvesting of protein crystals. This is achieved by fixing and thereafter removing dialysis membranes from the apparatus when required.

### BRIEF DESCRIPTION OF THE DRAWINGS

Various embodiments of the invention will hereinafter be described in conjunction with the appended drawings, provided to illustrate and not to limit the invention, wherein like designations denote like elements, and in which:

FIG. 1 is a top view of a microfluidic device, in accordance with an embodiment of the invention;

FIG. 2 is a cross-sectional view of a portion of the microfluidic device taken along axis Y1-Y2 shown in FIG. 1;

FIG. 3 is a bottom view of a microfluidic base plate, in accordance with an embodiment of the invention;

FIG. 4 is a bottom view of the microfluidic base plate, in accordance with another embodiment of the invention;

FIG. 5 is a bottom view of the microfluidic base plate, in accordance with yet another embodiment of the invention;

FIG. 6 is a bottom view of a portion of the microfluidic base plate, in accordance with an embodiment of the invention; and

FIG. 7 is a flowchart illustrating a method for conducting a micro-volume dialysis-based protein crystallization experiment in the microfluidic device, in accordance with an embodiment of the invention.

### DETAILED DESCRIPTION OF THE INVENTION

Various embodiments of the invention provide a microfluidic device and a method for conducting microfluidic experiments such as dialysis-based experiments. The microfluidic device includes a microtiter plate and a microfluidic base plate. The microtiter plate includes multiple wells, which act as reservoir for fluids. The microfluidic base plate includes multiple through-holes, wherein each through-hole is capable of holding fluids with volumes in microliters, nanoliters, and picoliters. The microfluidic base plate further comprises a microfluidic channel, wherein the microfluidic channel and the multiple through-holes form a network for sample delivery and storage. The two ends of the microfluidic channel are connected to a sample inlet port and a sample outlet port respectively. The sample inlet port is used for loading a sample, and the sample outlet port is used for purging the excess sample out of the microfluidic device.

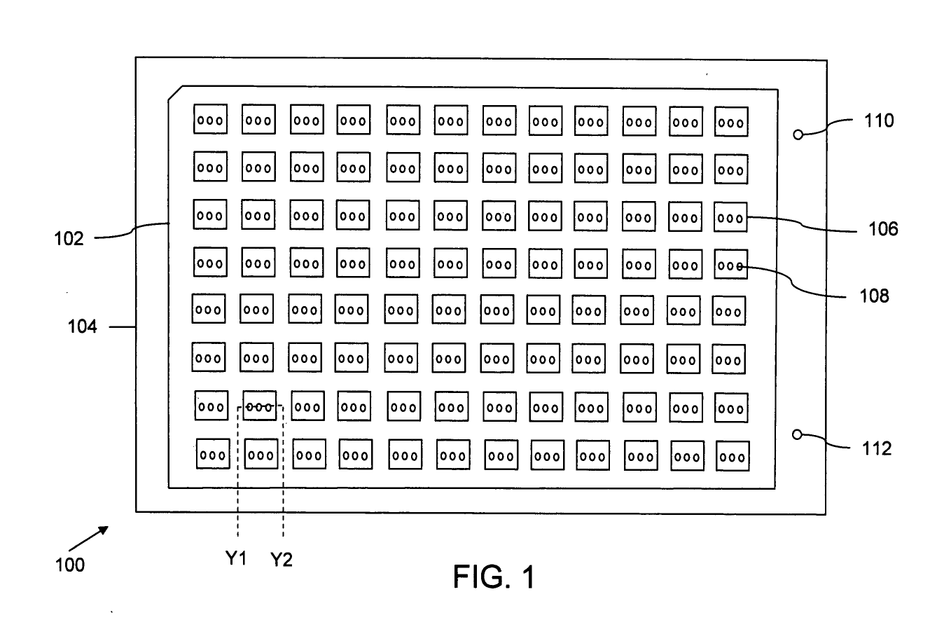

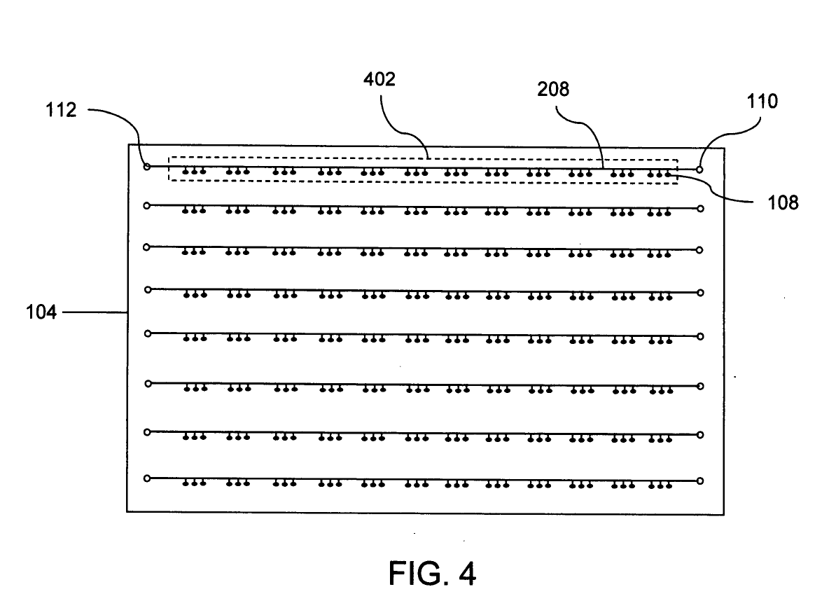

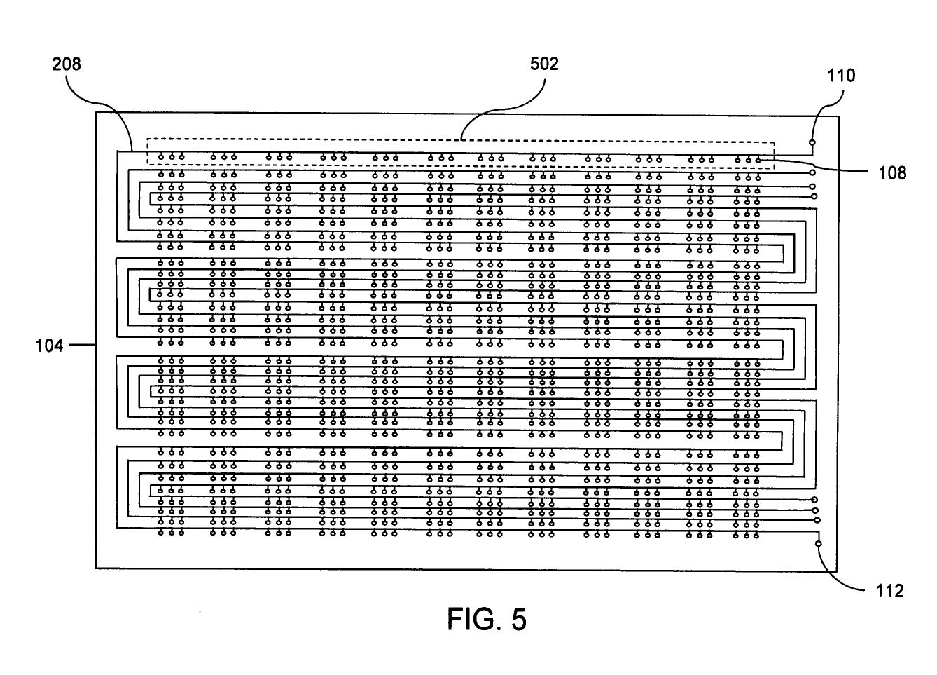

FIG. 1 is a top view of a microfluidic device 100. Microfluidic device 100 includes a microtiter plate 102 and a microfluidic base plate 104. Microtiter plate 102 is a bottomless plate. Examples of a commercially available bottomless microtiter plate include MatriCal's MGB096-1-PS-LG. In other embodiments of the invention, microtiter plate 102 may be a portion of a standard microtiter plate. For example, microtiter plate 102 may be one-fourth of a standard 96 well microtiter plate comprising 24 wells. As shown in FIG. 1, microtiter plate 102 includes multiple wells, and each well is referred to as well 106. Well 106 is a reservoir for fluids, which may be deposited by either manual pipetting or robotic pipetting. Microfluidic base plate 104 comprises multiple through-holes, and each through-hole is referred to as through-hole 108. Microtiter plate 102 is placed over microfluidic base plate 104 such that each well 106 overlies one or more through-holes 108. In another embodiment of the invention, some wells 106 may not overlie any through-hole 108. Each through-hole 108 is capable of holding fluids with volumes in microliters, nanoliters, and picoliters. Further, microfluidic base plate 104 comprises a sample inlet port 110 for loading of a sample, and a sample outlet port 112 for purging out the excess sample. The sample loaded in microfluidic device 100 through sample inlet port 110 passes via sample inlet port 110 to through-hole 108 by vacuum force, capillary force, centrifuge force, or pneumatic force. After the loading is complete, excess sample can be purged out of sample outlet port 112. According to other embodiments of the invention, microfluidic base plate 104 may comprise multiple sample inlet ports and sample outlet ports as described in conjunction with FIG. 4 and FIG. 5. In other embodiments of the invention, at least one of the sample inlet ports and the sample outlet ports may underlie well 106.

According to an embodiment of the invention, microfluidic device 100 is used for conducting micro-volume dialysis-based reactions involving 1 protein sample with 96 different reagents in sets of 3 through-holes 108, i.e., microtiter plate 102 includes 96 wells 106, and each well 106 overlies three through-holes 108. Such a microfluidic device 100 is represented as a 1.96×3 microfluidic device. According to various embodiments of the invention, microfluidic device 100 may contain a different number of wells 106 and through-holes 108. For example, microfluidic device 100 may be 1.1536, 1.384, 1.96, 1.48, 1.24, 1.6, 1.2, 1.1, 8.12×1, 8.12×3, 1.96×2, 1.96×6, 2.96×3, 4.96×3, 1.384×2, and 8.48×3, without deviating from the scope of the invention.

The designing of microfluidic device 100 depends on various technologies used for the fabrication of microtiter plate 102 and microfluidic base plate 104. The fabrication is governed by factors such as dimensions of through-holes 108, and properties of microfluidic device 100, for example rigidity etc. Examples of the technologies used for the fabrication include micromachining, hot embossing, injection molding of plastics, photolithography, Deep Reactive Ion Etching (DRIE), engraving, electroplating, and the like. Different techniques may be used to fabricate microtiter plate 102 and microfluidic base plate 104, or a single technique may be used to fabricate microtiter plate 102 and microfluidic base plate 104 in a single arrangement. For example, injection molding may be used to fabricate microtiter plate 102 and microfluidic base plate 104 in a single step. Examples of materials used for fabricating microtiter plate 102 and microfluidic base plate 104 include epoxy, polyurethane, polystyrene, polypropylene, polycarbonate, cyclic polyolefin (COC), polyoxymethylene, polyetherimide, polymethyl methacrylate (PMMA), and polyethylene terephthalate (PET).

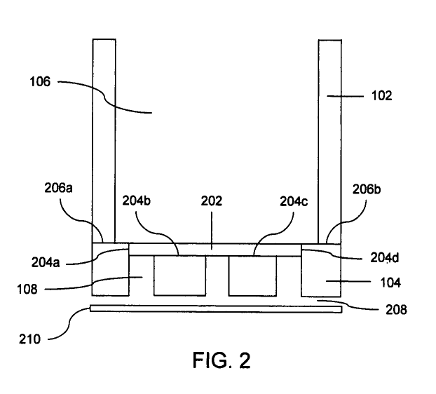

In FIG. 1, YI-Y2 represents the axis at which a cross-sectional view of a portion of microfluidic device 100 is considered in FIG.2.

FIG. 2 is a cross-sectional view of a portion of microfluidic device 100 taken along the axis Y1-Y2, in accordance with an embodiment of the invention. FIG. 2 shows a portion of microfluidic device 100 containing a dialysis membrane 202, surfaces 204a, 204b, 204c and 204d of microfluidic base plate 104, surfaces 206a and 206b of microfluidic base plate 104, a microfluidic channel 208, and a bottom sealing film 210. Microtiter plate 102 overlies microfluidic base plate 104 in such a way that each well 106 overlies three through-holes 108 present in microfluidic base plate 104.

Dialysis membrane 202 is attached to the top surface of microfluidic base plate 104, within a recess formed due to overlying of microtiter plate 102 on microfluidic base plate 104. Dialysis membrane 202 is fixed on microfluidic base plate 104 using an adhesive such as epoxy or urethane adhesive. The adhesive is applied on surfaces 204a, 204b, 204c and 204d of microfluidic base plate 104. This results in the formation of a strong bond between microfluidic base plate 104 and dialysis membrane 202 under dry conditions. Subsequent to the application of the adhesive, dialysis membrane 202 is pressed against microfluidic base plate 104. Examples of commercially available adhesives include Epon 828, Epon 919, 3M Industrial Adhesive 826, 3M Industrial Adhesive 847, Epotek U300, Aremco-Bond 805, Aremco-Bond 2315, Bondmaster M688, Bondmaster M773, Smooth-on Task-9, and Smooth-on Task-10.

It will be apparent to a person skilled in the art that a plurality of dialysis membranes 202 can be similarly attached to microfluidic base plate 104 in the areas which comprise other wells 106. Therefore, each well 106 of microfluidic device 100 has a separate dialysis membrane 202 placed over a group of through-holes 108. Such an arrangement allows for the elimination of sample cross-contamination.

According to another embodiment of the invention, dialysis membrane 202 can be attached to microtiter plate 102. Such an attachment includes fixing of dialysis membrane 202 on the under-side of each well 106 of microtiter plate 102.

Dialysis membrane 202 may be made up of materials such as cellulose ester, regenerated cellUlose, polyvinylidene difluoride, polyester, or polycarbonate. Examples of commercially available dialysis membranes include membranes from Spectrum Laboratories such as 133085, 133116, 129020, 128616, 131907, 132677, 138511 and 132712, snake skin dialysis tubings from Pierce such as 68035, 68011 and 68100, and track etched membranes such as GE's 1239560 and 1215046.

In an embodiment of the invention, microfluidic base plate 104 is attached to microtiter plate 102 using an adhesive such as epoxy or urethane adhesive that results in the formation of a strong bond between microfluidic base plate 104 and microtiter plate 102. The adhesive is applied on surfaces 206a and 206b of microfluidic base plate 104. Subsequently, microtiter plate 102 is pressed against microfluidic base plate 104 for attachment. However, such an attachment is not required when microtiter plate 102 and microfluidic base plate 104 are fabricated together using injection molding. Examples of commercially available adhesives include Epon 828, Epon 919, 3M Industrial Adhesive 826, 3M Industrial Adhesive 847, Epotek U300, Aremco-Bond 805, Aremco-Bond 2315, Bondmaster M688, Bondmaster M773, Smooth-on Task-9, and Smooth-on Task-10.

Microfluidic channel 208 is a part of microfluidic base plate 104, and forms a network with through-holes 108 for sample delivery and storage. Thus, all through-holes 108 are connected to each other by microfluidic channel 208. Further, the two ends (not shown in FIG. 2) of microfluidic channel 208 are connected to sample inlet port 110 and sample outlet port 112 respectively. Microfluidic channel 208 regulates the flow of the sample into through-holes 108.

Bottom sealing film 210 seals the bottom of microfluidic channel 208 with adhesives, and forms the bottom face of microfluidic base plate 104. Adhesives may be pressure sensitive adhesives or hot melt adhesives. According to an embodiment of the invention, bottom sealing film 210 may be an optically clear film such as a plastic film. Optical clarity enables microscopic or photographic viewing of reaction contents in through-holes 108.

In various embodiments of the invention, microfluidic device 100, microtiter plate 102, microfluidic base plate 104, through-holes 108, and microfluidic channel 208 of different shapes and sizes can be used depending on the requirement. For example, various micro-volume dialysis-based protein crystallization experiments require different volumes of protein samples. Such micro-volume dialysis-based protein crystallization experiments include protein crystallization condition screening, protein crystallization condition optimization, and protein crystal growth experiments. Table 1 below lists the different types of microfluidic device 100 desired for conducting different types of micro-volume dialysis-based protein crystallization experiments:

TABLE 1
Types of Microfluidic Device 100

| | | Dimensions of | | | | |
|---|---|---|---|---|---|---|
| | Volume of | Microfluidic Channel | | Dimensions of Through- | | |
| | Protein | 208 | | holes 108 | | Application |
| S. No. | Sample | Width | Depth | Internal Diameter | Thickness | Area |
| 1 | 1 nl-100 nl | 1 μm-1 mm | 1 μm-1 mm | 1 μm-10 mm | 50 μm-5 mm | Screening |
| | | | | | | Experiment |
| 2 | 10 nl-1 μl | 1 μm-1 mm | 1 μm-1 mm | 1 μm-10 mm | 50 μm-5 mm | Optimization |
| | | | | | | Experiment |
| 3 | 100 nl-10 μl | 1 μm-1 mm | 1 μm-1 mm | 1 μm-10 mm | 50 μm-5 mm | Growth |
| | | | | | | Experiment |
| 4 | 1 nl-10 μl | 1 μm-1 mm | 1 μm-1 mm | 50 μm-3 mm | 50 μm-5 mm | Screening, |
| | | | | | | Optimization |
| | | | | | | and Growth |
| | | | | | | Experiments |

The dimensions of microfluidic channel 208 and through-holes 108 listed in Table 1 are typically used in a 1.384, 1.96, 1.24, 1.2, or 1.1 microfluidic device.

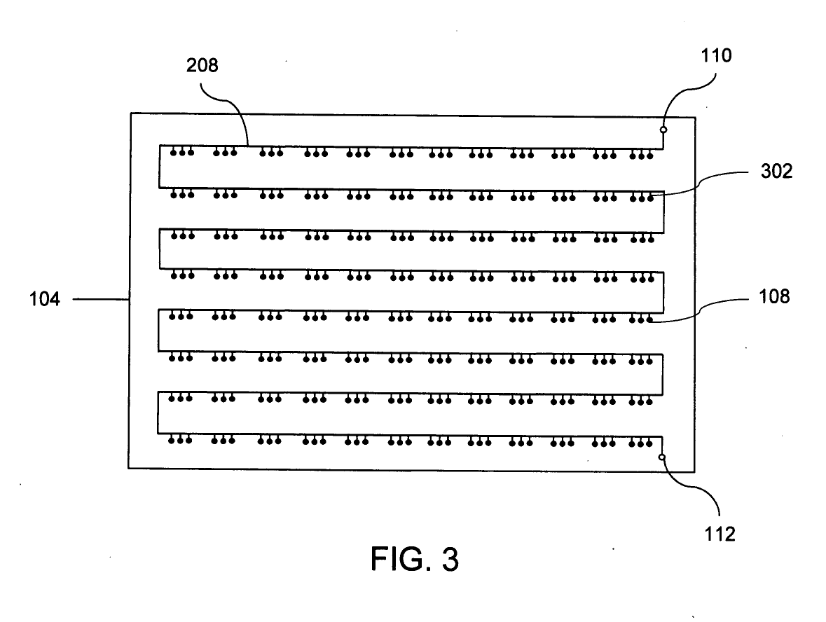

FIG. 3 is a bottom view of microfluidic base plate 104, in accordance with an embodiment of the invention. FIG. 3 shows microfluidic base plate 104 having 96 groups of three through-holes 108, side-arms 302 connecting through-holes 108 to microfluidic channel 208, sample inlet port 110, and sample outlet port 112. A protein sample is loaded through sample inlet port 110. Subsequently, the protein sample passes via microfluidic channel 208 into each through-hole 108. The excess protein sample in microfluidic channel 208 is purged out through sample outlet port 112, such that each loaded through-hole 108 acts as an isolated microfluidic dialysis chamber (that is, isolated from other microfluidic dialysis chambers connected to microfluidic channel 208).

In other embodiments of the invention, microfluidic base plate 104 may include multiple microfluidic channels 208. Several protein samples may be loaded through multiple microfluidic channels 208. This allows for conducting multiple sets of experiments simultaneously in microfluidic device 100. According to an embodiment of the invention, microfluidic base plate 104 is used for conducting eight different sets of micro-volume dialysis-based experiments. This has been further explained with the help of FIG. 4.

FIG. 4 is a bottom view of microfluidic base plate 104, in accordance with another embodiment of the invention. Microfluidic base plate 104 includes eight sets of thirty-six through-holes 108 each, each set hereinafter referred to as through-hole group 402. Further, microfluidic base plate 104 includes eight sets of sample inlet port 110 and sample outlet port 112. Each set of sample inlet port 110 and sample outlet port 112 forms the end points of one microfluidic channel 208. FIG. 4 shows eight different microfluidic channels 208. Each microfluidic channel 208 connects thirty-six through-holes 108 contained in through-hole group 402 to sample inlet port 110 and sample outlet port 112. This allows the carrying out of eight different sets of experiments involving eight different samples.

FIG. 5 is a bottom view of microfluidic base plate 104, in accordance with yet another embodiment of the invention. Microfluidic base plate 104 includes four sets of 288 through-holes 108 each. Each set is sub-divided into eight groups, each group hereinafter referred to as through-hole group 502. Further, microfluidic base plate 104 includes four sets of sample inlet port 110 and sample outlet port 112. Each set of sample inlet port 110 and sample outlet port 112 forms the end points of one microfluidic channel 208. FIG. 5 shows four different microfluidic channels 208. Each microfluidic channel 208 connects 288 through-holes 108 contained in eight through-hole groups 502 to sample inlet port 110 and sample outlet port 112. This allows the carrying out of four different sets of experiments involving four different samples.

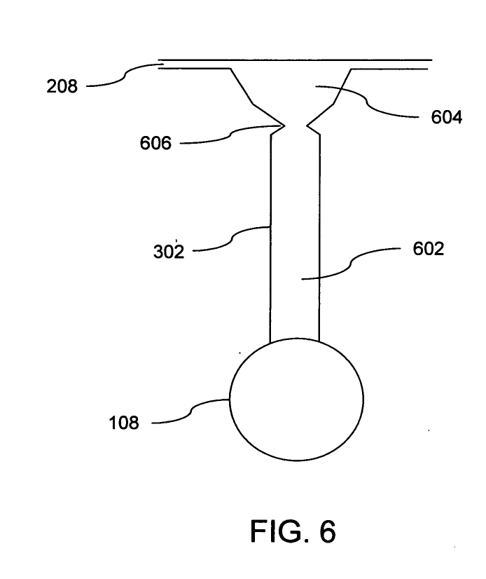

FIG. 6 is a bottom view of a portion of microfluidic base plate 104, in accordance with an embodiment of the invention. FIG. 6 shows through-hole 108, microfluidic channel 208, and side-arm 302 connecting through-hole 108 to microfluidic channel 208. Side-arm 302 includes a first reservoir 602 and a second reservoir 604. In an alternate embodiment of the invention, side-arm 302 may be devoid of first reservoir 602 and second reservoir 604. Further, side-arm 302 includes a constriction 606 between first reservoir 602 and second reservoir 604 that prevents the sample loaded into through-hole 108 from being sucked out by vacuum force when excess sample from microfluidic channel 208 is purged out. The purpose of first reservoir 602 and second reservoir 604 is to maintain a constant and isolated volume of sample in through-hole 108, in spite of the effects of osmosis between the sample in through-hole 108 and reagent in well 106. To accomplish this, first reservoir 602 holds an excess volume of sample to minimize the appearance of bubbles in through-hole 108 in case water from the sample is dialyzed out of through-hole 108 due to a higher molar concentration of the reagent in well 106 than that of the sample in through-hole 108. Second reservoir 604 holds an excess volume of sample to prevent through-holes 108 from getting inter-connected in case water is dialyzed into one or more through-holes 108 due to a higher molar concentration of the sample than that of the reagent.

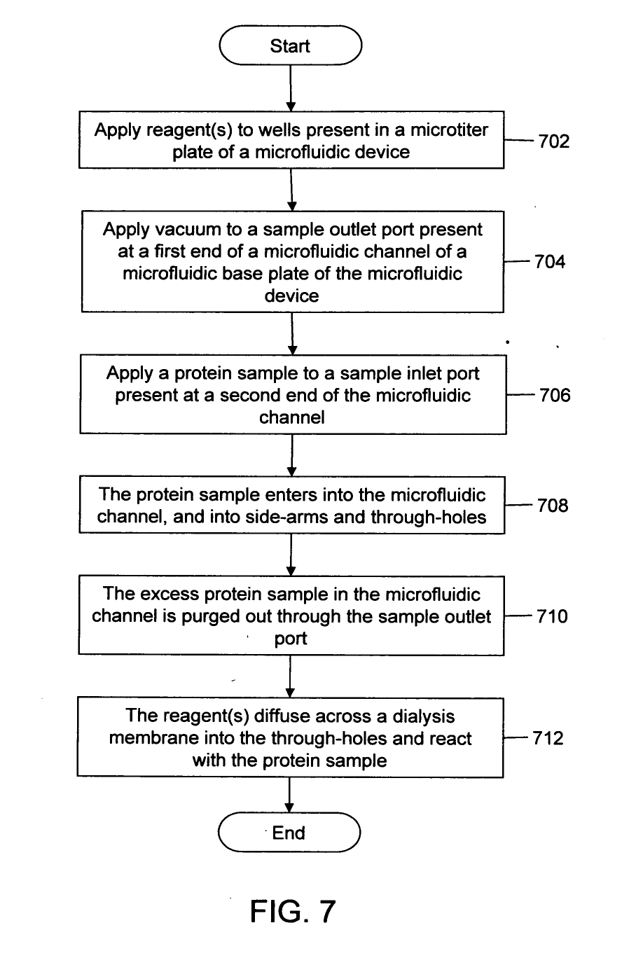

FIG. 7 is a flowchart illustrating a method for conducting a micro-volume dialysis-based protein crystallization experiment in microfluidic device 100, in accordance with an embodiment of the invention. At step 702, crystallization reagent is pipetted into wells 106. Subsequently, at step 704, vacuum is applied (using a vacuum source) at sample outlet port 112 to create a negative pressure inside a microfluidic network of microfluidic channel 208, side-arms 302, and through-holes 108. Thereafter, at step 706, a protein sample is applied to sample inlet port 110. At step 708, the protein sample enters microfluidic channel 208, and into side-arms 302 and through-holes 108 because of the negative pressure created inside the microfluidic network. According to this embodiment, sample loading is carried out using a vacuum loading method. In other embodiments of the invention, sample loading may be carried out using a pneumatic pressure method, a centrifuge loading method, a capillary flow method, or a combination of these. Alternatively, in another embodiment of the invention, an adhesive film can be used to seal sample inlet port 110. This allows for a high degree of air evacuation inside the microfluidic network. Thereafter, a sharp object can be used to puncture the adhesive film so that the protein sample is introduced into the microfluidic network by vacuum force. As will be apparent to a person skilled in the art, due to the continuous vacuum applied at sample outlet port 112, the excess protein sample in microfluidic channel 208 is purged out through sample outlet port 112, at step 710. However, the protein sample loaded in through-holes 108 remains due to surface tension. The design of side-arms 302 (as explained earlier with the help of FIG. 6) ensures that only the protein sample in microfluidic channel 208 is purged out. In other embodiments of the invention, mineral oil, silicone oil, fluorinated silicone oil, or perfluorocarbon liquid (like Fluorinert), or a combination of these with air can also be used to purge out the excess protein sample. In other embodiments of the invention, crystallization reagent may be added after the protein sample is loaded without deviating from the scope of the invention. The crystallization reagent passes through dialysis membranes 202, and reacts with the protein sample in through-holes 108, at step 712. The retention of the protein sample inside through-holes 108 depends upon the molecular weight cut-off of dialysis membrane 202. When dialysis membrane 202 is fabricated with a suitable molecular weight cut-off, the protein sample is retained inside through-holes 108 due to the semi-permeable nature of dialysis membrane 202. The dialysis membrane molecular weight cut-off is determined as the solute size (molecular weight) that is retained by at least 90%. Once the micro-volume dialysis-based protein crystallization experiment is complete, either dialysis membranes 202 or bottom sealing film 210 can be peeled off from microfluidic base plate 104 to harvest the protein crystals. The harvested protein crystals can then be used for further analysis.

The method for conducting the micro-volume dialysis-based protein crystallization experiment in microfluidic device 100 has been further explained with respect to the embodiment of the invention disclosed in FIG. 5. Microfluidic device 100 is used to conduct protein crystallization of four different protein samples. The four protein samples are separately loaded through each of the four sample inlet ports 110. Each of the protein samples then diffuses through corresponding microfluidic channel 208 to a corresponding set of 288 through-holes 108 in microfluidic base plate 104. Due to the higher molecular weights, protein samples are unable to pass through dialysis membranes 202 into wells 106. Excess protein samples in microfluidic channels 208 are purged out through each of the sample outlet ports 112. The crystallization reagents contained in wells 106 pass through dialysis membranes 202, and react with the protein samples in through-holes 108. Thus, four different protein crystallization experiments are carried out. Examples of crystallization reagents may include polyethylene glycol, ammonium sulfate, sodium chloride, and isopropanol alcohol. After the completion of the experiments, either dialysis membranes 202 or bottom sealing film 210 can be peeled off from microfluidic base plate 104 for further analysis.

Micro-volume dialysis-based protein crystallization experiments as described above allow for a quick and efficient identification of conditions that can lead to the growth of large single protein crystals. The protein crystals can then be analyzed by X-ray crystallography to determine the structure of protein, protein-ligand complex, protein-protein complex, or protein-DNA complex. In such protein crystallization experiments, the ratio of protein samples to crystallization reagents is selected from a range of 1:1 to 1:10,000. Microfluidic device 100 disclosed in the invention is suitable for conducting crystallization reactions that involve protein samples with volumes equal to or less than 5 μl.

According to an embodiment of the invention, microfluidic device 100 is used to conduct protein-binding experiments. Examples of such protein-binding experiments include protein-ligand binding tests, protein equilibrium dialysis assays, protein-protein interaction assays, protein-DNA interaction assays, Enzyme-linked Immunosorbent Assays (ELISA) and bead-based immunoassays. In these experiments, a protein sample is reacted with a ligand, an enzyme, or an antibody under controlled conditions.

According to an embodiment of the invention, microfluidic device 100 is used to conduct protein purification experiments and for screening of purification conditions. For conducting such experiments, protein samples are screened against a variety of reagents for their solubility.

According to an embodiment of the invention, microfluidic device 100 is used to conduct cell-based assays, such as calcium flux, pharmacokinetics, pharmacodynamics, and drug screening assays.

According to another embodiment of the invention, the method to attach the dialysis membrane can employ the use of mechanical means for fixing the dialysis membrane. Examples of such devices include Pierce's Slide-A-Lyzer Dialysis Cassette,

Spectrum Lab's Spectra/Por Float-A-Lyzer, Harvard Apparatus' Ultra-Micro DispoDialyzer, and Linden Biosciences' Rapid Equilibrium Dialysis device.

The various embodiments of the invention provide an apparatus and a method that are cost-effective. Additionally, the various embodiments of the invention provide an apparatus and a method for handling samples associated with micro-volume dialysis-based reactions. Further, the various embodiments of the invention reduce evaporation of samples by introducing one or more microfluidic channels inside the microfluidic base plate. The microfluidic channels ensure a uniform and constant supply of samples to the through-holes of the microfluidic base plate. The design of the microfluidic channels and the through-holes also ensures complete isolation of the samples and reagents in each through-hole and each well, respectively. Moreover, various embodiments of the invention provide an efficient approach for fixing and thereafter removing dialysis membranes from the microfluidic device. This enables easy harvesting of protein crystals from the microfluidic device after the completion of a protein crystallization reaction.

While various embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention.

What is claimed is:

1. An apparatus for conducting a micro-volume experiment, the apparatus comprising:
a. a microtiter plate, wherein the microtiter plate comprises one or more wells;
b. one or more membranes; and
c. a microfluidic base plate, wherein the microfluidic base plate comprises a plurality of through-holes, and wherein the microfluidic base plate, the microtiter plate and the one or more membranes are positioned such that at least one of the one or more membranes lies between at least one of the one or more wells and at least one of the plurality of through-holes.

2. The apparatus of claim 1, wherein the microtiter plate is a bottomless plate.

3. The apparatus of claim 1, wherein the micro-volume experiment is a dialysis-based micro-volume experiment.

4. The apparatus of claim 1, wherein the internal diameter of each of the plurality of through-holes is in a range of 1 to 10,000 micrometers.

5. The apparatus of claim 1, wherein each of the plurality of through-holes is capable of holding fluids in a range of 1 picoliter to 1000 microliters.

6. The apparatus of claim 1, wherein the microtiter plate and the microfluidic base plate are positioned such that each of the one or more wells overlies at least one through-hole.

7. The apparatus of claim 1, wherein the microfluidic base plate further comprises at least one microfluidic channel, and wherein the at least one microfluidic channel connects the plurality of through-holes to form a network of through-holes.

8. The apparatus of claim 7, wherein the at least one microfluidic channel is connected to each of the plurality of through-holes by a side-arm.

9. The apparatus of claim 8, wherein the side-arm comprises one or more reservoirs.

10. The apparatus of claim 9, wherein the side-arm further comprises one or more constrictions.

11. The apparatus of claim 7, wherein the at least one microfluidic channel has a sample inlet port and a sample outlet port.

12. The apparatus of claim 7, wherein the width of the at least one microfluidic channel is in a range of 1 to 1000 micrometers, and the depth of the at least one microfluidic channel is in a range of 1 to 1000 micrometers.

13. The apparatus of claim 1, wherein the one or more membranes are semi-permeable membranes.

14. The apparatus of claim 1, wherein the one or more membranes are removably attached to the microfluidic base plate on a top surface of the microfluidic base plate facing the microtiter plate.

15. The apparatus of claim 1, wherein the apparatus further comprises a bottom sealing film, and wherein the bottom sealing film is removably attached to an under-side of the microfluidic base plate.

16. The apparatus of claim 15, wherein the bottom sealing film is attached to the microfluidic base plate using an adhesive.

17. A method for conducting a micro-volume experiment in a microfluidic apparatus, the microfluidic apparatus comprising a microtiter plate having one or more wells, one or more membranes, and a microfluidic base plate having a plurality of through-holes, wherein the microtiter plate, the one or more membranes, and the microfluidic base plate are positioned such that at least one of the one or more membranes lies between at least one of the one or more wells and at least one of the plurality of through-holes, the method comprising:
a. adding a reagent into the at least one of the one or more wells;
b. loading a sample into the at least one of the plurality of through-holes; and
c. allowing the reagent to diffuse from the at least one of the one or more wells, through the at least one of the one or more membranes into the at least one of the plurality of through-holes.

18. The method of claim 17, wherein the micro-volume experiment is a dialysis-based micro-volume experiment.

19. The method of claim 17, wherein the micro-volume experiment comprises a protein crystallization reaction.

20. The method of claim 17, wherein the micro-volume experiment comprises a polymerase chain reaction.

21. The method of claim 17, wherein the micro-volume experiment comprises a protein binding test.

22. The method of claim 17, wherein the micro-volume experiment comprises protein calorimetry.

23. The method of claim 17, wherein the micro-volume experiment comprises cell-free protein synthesis.

24. The method of claim 17, wherein the micro-volume experiment comprises a cell-based assay.

25. The method of claim 17, wherein the sample is loaded into the at least one of the plurality of through-holes by applying the sample to a sample inlet port of a microfluidic channel, wherein the microfluidic channel is connected to the at least one of the plurality of through-holes and the sample inlet port is present at a first end of the microfluidic channel.

26. The method of claim 25, wherein the sample applied to the sample inlet port enters into the at least one of the plurality of through-holes via a side-arm, wherein the side-arm connects the microfluidic channel to the at least one of the plurality of through-holes.

27. The method of claim 25, wherein the sample applied to the sample inlet port is made to enter the microfluidic channel and the at least one of the plurality of through-holes by creating a negative pressure in the microfluidic channel.

28. The method of claim 27, wherein the negative pressure is created by applying vacuum to a sample outlet port of the microfluidic channel, wherein the sample outlet port is present at a second end of the microfluidic channel.

29. The method of claim 25, wherein the sample applied to the sample inlet port is made to enter the microfluidic channel and the at least one of the plurality of through-holes by pneumatic pressure.

30. The method of claim 28, wherein the excess sample present in the microfluidic channel, after the sample loading is complete, is purged out through the sample outlet port.

31. The method of claim 30, wherein the side-arm prevents the sample loaded into the at least one of the plurality of through-holes from leaving the at least one of the plurality of through-holes during purging.

32. The method of claim 30, wherein the excess sample is purged out by applying vacuum to the sample outlet port.

33. The method of claim 30, wherein the excess sample is purged out through the sample outlet port using a material selected from a group comprising air, mineral oil, silicone oil, fluorinated silicone oil, and perfluorocarbon liquid.

34. The method of claim 17, wherein the reagent is added into the at least one of the one or more wells by pipetting.
